(19) United States
(12) Patent Application Publication
(10) Pub. No.: US 2011/0093651 A1
(43) Pub. Date: Apr. 21, 2011

(54) DATA STORAGE APPARATUS AND CONTROLLING METHOD OF THE DATA STORAGE APPARATUS

(75) Inventor: Takehiko Kurashige, Ome-shi (JP)

(73) Assignee: Kabushiki Kaisha Toshiba, Tokyo (JP)

(21) Appl. No.: 12/883,020

(22) Filed: Sep. 15, 2010

(30) Foreign Application Priority Data
Oct. 21, 2009 (JP) 2009-242660

(51) Int. Cl. G06F 12/02; G06F 12/00

(52) U.S. Cl. 711/103; 711/170; 711/112; 711/E12.001; 711/E12.008

(57) ABSTRACT

According to one embodiment, a data storage apparatus includes a first nonvolatile storage, a second nonvolatile storage and a controller. The controller is configured to control data writing and data reading for the first and second nonvolatile storage. The controller includes an allocation control module. The allocation control module is configured to allocate part of a storage area of the first nonvolatile storage to a logical address space and to allocate part or all of a storage area of the second nonvolatile storage to the logical address space in order to use the part of the storage area of the first nonvolatile storage allocated to the logical address space as storage area of substantial data, and to use part or whole of a remaining part of the storage area of the first nonvolatile storage not allocated to the logical address space as nonvolatile cache for the second nonvolatile storage.

### CROSS-REFERENCE TO RELATED APPLICATIONS

This application is based upon and claims the benefit of priority from Japanese Patent Application No. 2009-242660, filed Oct. 21, 2009; the entire contents of which are incorporated herein by reference.

### FIELD

Embodiments described herein relate generally to a technique of controlling allocation of a storage region, which is suitable for, for example, hybrid hard disk drives (HDDs) including a nonvolatile semiconductor memory.

### BACKGROUND

In recent years, various types of personal computers such as notebook computers and desk-top computers have been widely used. Personal computers of these types are generally equipped with an HDD as an external storage device serving as a boot disk.

To improve response performance of such HDDs, so-called hybrid HDDs including a nonvolatile semiconductor memory have been developed (for example, see Jpn. Pat. Appln. KOKAI Pub. No. 6-314177).

Current hybrid HDDs are broadly classified into the following two types: (1) hybrid HDDs which allocate a nonvolatile semiconductor memory to part of a logical address space (which is expected to be frequently accessed) and use it as a storage area for substantial data; and (2) hybrid HDDs which use a nonvolatile semiconductor memory as nonvolatile cache area for the HDDs.

However, hybrid HDDs of type 1 cannot achieve improvement in access to logical address spaces to which the HDDs are allocated, and hybrid HDDs of type 2 cannot connect increase in capacity of nonvolatile semiconductor memories, which have been achieved by virtue of recent reduction in cost, to increase in capacity of the hybrid HDDs.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary diagram illustrating an example of a structure of a data storage apparatus according to an embodiment.

FIG. 2 is an exemplary diagram illustrating an example of an address map of the data storage apparatus of the embodiment.

FIG. 3 is an exemplary diagram illustrating a modification of the structure of the data storage apparatus of the embodiment.

### DETAILED DESCRIPTION

Various embodiments will be described hereinafter with reference to the accompanying drawings.

In general, according to one embodiment, a data storage apparatus includes a first nonvolatile storage, a second nonvolatile storage and a controller. The controller is configured to control data writing and data reading for the first and second nonvolatile storage. The controller includes an allocation control module. The allocation control module is configured to allocate part of a storage area of the first nonvolatile storage to a logical address space and to allocate part or all of a storage area of the second nonvolatile storage to the logical address space in order to use the part of the storage area of the first nonvolatile storage allocated to the logical address space as storage area of substantial data, and to use part or whole of a remaining part of the storage area of the first nonvolatile storage not allocated to the logical address space as nonvolatile cache for the second nonvolatile storage.

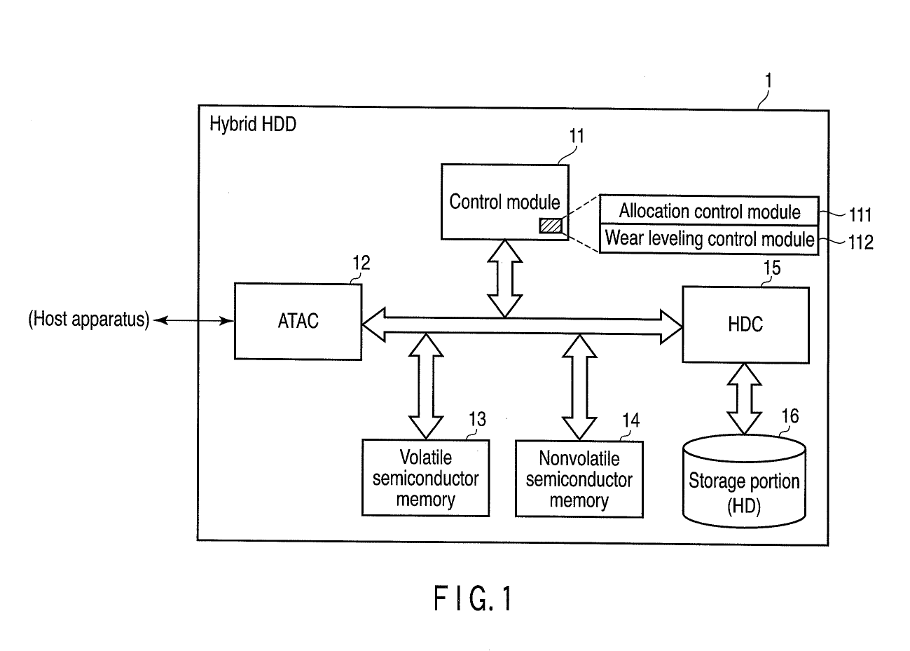

FIG. 1 is an exemplary diagram illustrating an example of a structure of a data storage apparatus (hybrid HDD 1) according to the embodiment.

As illustrated in FIG. 1, the hybrid HDD 1 includes a control module 11, an AT attachment controller (ATAC) 12, a volatile semiconductor memory 13, a nonvolatile semiconductor memory 14, a hard disk controller (HDC) 15, and a storage portion 16.

The controller 11 is a microprocessor for controlling operation in the hybrid HDD 1. The control module 11 includes an allocation control module 111 and a wear leveling control module 112. The ATAC 12 is a controller which connects the hybrid HDD 1 with a host apparatus, which write data in, and read data out of, the hybrid HDD 1, by an AT attachment (ATA) interface.

The nonvolatile semiconductor memory 13 is, for example, a dynamic RAM (DRAM [random access memory]), which temporarily stores write data transmitted from the host apparatus and read data to be transmitted to the host apparatus, while the hybrid HDD 1 is in a power-on state.

In contrast, the nonvolatile semiconductor memory 14 is, for example, a NAND flash memory, which can maintain stored data even while the hybrid HDD 1 is in a power-off state. In addition, the storage portion 16 is an HDD which is formed of, for example, a magnetic head and a magnetic disk, and can maintain stored data even while the hybrid HDD 1 is in a power-off state. The HDC 15 is a controller which drives and controls the magnetic head and the magnetic disk of the storage portion 16.

The hybrid HDD 1 achieves efficient use of a storage area, while response performance thereof is improved, by controlling allocation of the nonvolatile semiconductor memory 14 and the storage portion 16 to the logical address space of the hybrid HDD 1, which is recognized by the host apparatus. This point will now be detailed below.

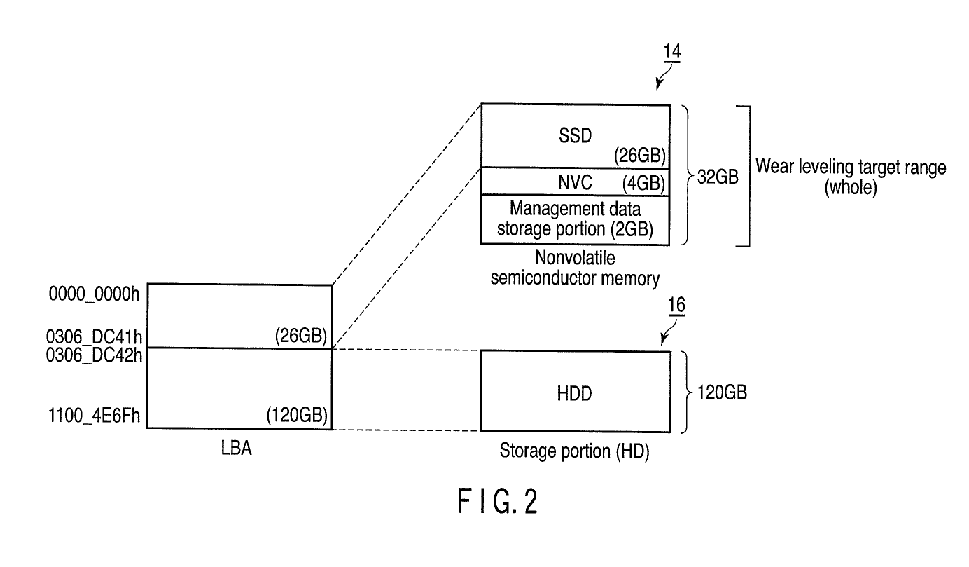

FIG. 2 is an exemplary diagram illustrating an example of an address map of the hybrid HDD 1.

In this embodiment, suppose that the nonvolatile semiconductor memory 14 includes a storage capacity of 32 GB, and the storage portion 16 includes a storage capacity of 120 GB. In addition, the hybrid HDD 1 of the embodiment provides the host apparatus with a storage capacity of 146 GB (which is larger than 120 GB of the storage portion 16, and smaller than 152 GB being the sum of the capacities of the nonvolatile semiconductor memory 14 and the storage portion 16). Specifically, the hybrid HDD 1 makes itself appear to the host apparatus to include a storage capacity of 146 GB. Therefore, the host apparatus executes writing of data and reading of data in and from a logical block address (LBA) space of 146 GB having addresses from 0000_{—}0000h to 1100_{—}4E6Fh. The hybrid HDD 1 converts a logical address designated by the host apparatus into a physical address, and executes access to the nonvolatile semiconductor memory 14 or the storage portion 16.

Therefore, the allocation control module 111 of the control module 11 allocates, for example, 26 GB in a storage capacity of 32 GB, which the nonvolatile semiconductor memory 14 includes, to 0000_{—}0000h to 0306_DC41h, that is, the first half part (26 GB from the head address) of the logical address space. In addition, the allocation control module 111 allocates 120 GB of the storage portion 16 to 0306_DC42h to 1100_{—}4E6Fh, that is, the second half part of the logical address space following the first half part.

In addition, among the remaining 6 GB not allocated to the logical address space in the storage capacity of 32 GB of the nonvolatile semiconductor memory 14, the allocation control module 111 of the control module 11 manages 4 GB to use it as a nonvolatile cache (NVC), and manages 2 GB to use it as a management data storage portion for storing various management data such as a cluster table relating logical addresses to physical addresses.

Specifically, in the hybrid HDD 1, part of the nonvolatile semiconductor memory 14 is used as a solid-state drive (SSD), and another part of the nonvolatile semiconductor memory 14 is used as a nonvolatile cache of the storage portion 16. The cache method used when the nonvolatile semiconductor memory 14 is used as a nonvolatile cache of the storage portion 16 is not specifically provided in this embodiment.

Thereby, the hybrid HDD 1 achieves the following points simultaneously: (1) improvement in response performance of access to the logical address space to which the storage portion 16 is allocated; and (2) connection of increase in capacity of the nonvolatile semiconductor memory 14 to increase in capacity of the hybrid HDD 1.

To simplify the explanation, FIG. 2 shows a map in which 26 GB from the head among 32 GB of the nonvolatile semiconductor memory 14 is used as an SSD, the following 4 GB is used as an NVC, and the following 2 GB is used as management data storage portion. Actually, however, the allocation control module 11 of the control module 11 dynamically allocates each region of the nonvolatile semiconductor memory to any of the above three uses, and manages a result of the allocation as management data in the management data storage portion.

In addition, although FIG. 2 shows an example in which part of the nonvolatile semiconductor memory 14 is allocated to the first half part of the logical address space and the storage portion 16 is allocated to the second half part following the first half part, it is also possible to allocate 26 GB of the nonvolatile semiconductor memory 14, which is shown by the management data to be used as an SSD, and 120 GB of the storage portion 16 in a mixed state to the logical address space with no restrictions. For example, in the case where the hybrid HDD 1 is mounted as a boot disk of a personal computer (PC) whose operation is controlled by an operating system (OS), data reading which is executed by the OS in startup tends to localize in a part of a predetermined volume of storage capacity from the head of the logical address space. Therefore, it is preferable that the allocation control module 111 performs control to allocate the nonvolatile semiconductor memory 14 to the predetermined volume of storage capacity from the head of the logical address space. This control can improve response performance achieved directly after the computer is powered.

In the example shown in FIG. 2, in which part of the nonvolatile semiconductor memory 14 is allocated to the first half part of the logical address space and the storage portion 16 is allocated to the second half part following the first half part, response performance achieved directly after the computer is powered can be improved as a matter of course, for the reason stated above.

In addition, although this embodiment shows an example in which 26 GB among 32 GB of the nonvolatile semiconductor memory 14 is used as SSD, 4 GB is used as an NVC, and 2 GB is used as management data storage portion, the allocation control module 11 of the control module 11 includes a function of setting allocation of 32 GB of the nonvolatile semiconductor memory 14, based on a command such as a host protected area (HPA) feature set specified by the ATA, when such a command is received by the ATAC 12. Specifically, it is possible to designate the capacity of the SSD and the capacity of the NVC in the hybrid HDD 1 from the host apparatus.

On the other hand, the wear leveling control module 112 executes wear leveling processing for the nonvolatile semiconductor memory 14, to level the numbers of erases of the storage area in the nonvolatile semiconductor memory 14. In this processing, the wear leveling control module 112 does not level the number of erases of the storage area for each of the three uses, but executes wear leveling processing for the whole nonvolatile semiconductor memory 14.

More specifically, for example, since update of data stored in the NAND flash memory is executed by nullification of the old data and new writing of updated data, compaction is performed, in which effective data in two blocks occupied by nullified data at a considerably increased rate is rearranged in one block. Therefore, a block which has become empty by the compaction is positioned at the last of a waiting queue to be used when a new empty block is required for any of the three uses, regardless of which of the three uses the block was used for. Thereby, wear leveling processing for the whole nonvolatile semiconductor memory 14 is executed.

In the wear leveling processing by the wear leveling control module 112 of the control module 11 in the hybrid HDD 1, it is important to execute wear leveling processing for the whole nonvolatile semiconductor memory 14, and any method other than the above method can be adopted as method of the wear leveling processing.

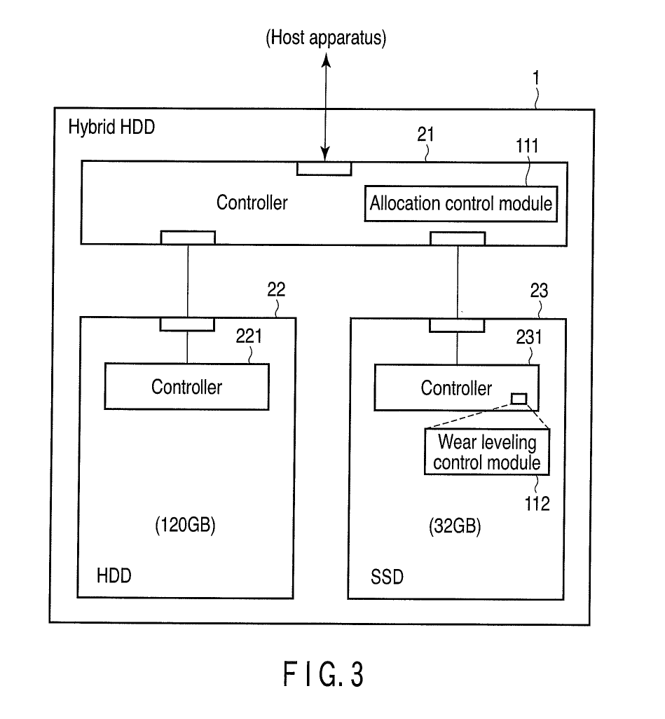

FIG. 3 is an exemplary diagram illustrating a modification of the structure of the data storage apparatus of the embodiment.

As illustrated in FIG. 1, in the hybrid HDD 1, part of the nonvolatile semiconductor memory 14 mounted to the hybrid HDD 1 is used as an SSD, and another part thereof is used as nonvolatile cache of the storage portion 16, by allocation control by the control module 11. In addition, wear leveling processing for the nonvolatile semiconductor memory 14 is also controlled by the control module 11.

In comparison with this, a hybrid HDD 1 according to the modification illustrated in FIG. 3 is equipped with two independent storage devices, that is, an HDD 22 including a controller 221 and an SSD 23 including a controller 231, and also equipped with a controller 21 which operates as a host apparatus for the HDD 22 and the SSD 23 and controls operation of the whole hybrid HDD 1. In addition, the controller 21 performs control to allocate the HDD 22 and part of the SSD 23 to the logical address space, and use another part of the SSD 23 as nonvolatile cache of the HDD 22. The SSD 23 does not recognize uses of its storage area, and thus wear leveling processing by the controller 231 of the SSD 23 is executed for the whole SSD 23.

Also according to the structure illustrated in FIG. 3, part of the SSD 23 is used as storage area for substantial data, and another part thereof is used as nonvolatile cache area of the HDD 22. Therefore, the following two points are simultaneously achieved: (1) improvement in response performance of access to the logical address space to which the HDD 22 is allocated; and (2) connection of increase in capacity of the SSD 23 to increase in capacity of the hybrid HDD 1.

As described above, according to the hybrid HDD 1 of the embodiment, response performance is improved, and allocation control for effective use of storage areas is achieved.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage apparatus comprising:
a first nonvolatile storage;
a second nonvolatile storage; and
a controller configured to control data writing and data reading for the first nonvolatile storage and the second nonvolatile storage,
wherein the controller comprises an allocation control module configured to control allocation of storage areas of the first nonvolatile storage and the second nonvolatile storage to a logical address space, the allocation control module being configured to allocate part of a storage area of the first nonvolatile storage to a logical address space and to allocate part or all of a storage area of the second nonvolatile storage to the logical address space in order to use the part of the storage area of the first nonvolatile storage allocated to the logical address space as storage area of substantial data, and to use at least some of a remaining part of the storage area of the first nonvolatile storage that is not allocated to the logical address space as nonvolatile cache for the second nonvolatile storage.

2. The apparatus of claim 1, wherein:
the first nonvolatile storage comprises a nonvolatile semiconductor memory; and
the second nonvolatile storage comprises a magnetic disk.

3. The apparatus of claim 2, wherein the controller further comprises a wear leveling control module configured to level the numbers of erases for the whole storage area of the nonvolatile semiconductor memory.

4. The apparatus of claim 1, wherein the allocation control module is configured to allocate the part of the storage area of the first nonvolatile storage to a part starting from a head address of the logical address space, and to allocate all the storage area of the second nonvolatile storage to a part of the logical address space starting from an address following the part of the logical address space to which the part of the storage area of the first nonvolatile storage is allocated.

5. The apparatus of claim 1, wherein the allocation control module is configured to allocate the part of the storage area of the first nonvolatile storage to a part from a head address to a predetermined address of the logical address space.

6. The apparatus of claim 1, wherein the allocation control module comprises a setting module configured to set a capacity of the part of the storage area of the first nonvolatile storage to be allocated to the logical address space, based on a command input.

7. The apparatus of claim 1, wherein the allocation control module is configured to allocate the part of the remaining part of the storage area of the first nonvolatile storage, which is not allocated to the logical address space, as nonvolatile cache region for the second nonvolatile storage, and to allocate a remaining part of the remaining part of the storage area of the first nonvolatile storage as management data storage area to store management data.

8. The apparatus of claim 7, wherein the allocation control module comprises a setting module configured to set a capacity to be allocated as the nonvolatile cache area for the second nonvolatile storage and a capacity to be allocated as the management data storage area to store the management data, among the remaining part of the storage area of the first nonvolatile storage, based on a command input.

9. A control method of a data storage apparatus comprising a first nonvolatile storage and a second nonvolatile storage, the method comprising:
controlling allocation of storage areas of the first nonvolatile storage and the second nonvolatile storage to the logical address space,
wherein the controlling comprising allocating part of a storage area of the first nonvolatile storage to a logical address space, and allocating part or all of a storage area of the second nonvolatile storage to the logical address space in order to use the part of the storage area of the first nonvolatile storage allocated to the logical address space as storage area of substantial data, and to use at least some of a remaining part of the storage area of the first nonvolatile storage not allocated to the logical address space as nonvolatile cache for the second nonvolatile storage.

10. The method of claim 9, further comprising leveling the numbers of erases for the whole storage area of a nonvolatile semiconductor memory, which is included in the first nonvolatile storage as the storage area.
